(19) United States
(12) Patent Application Publication
(10) Pub. No.: US 2018/0328473 A1
(43) Pub. Date: Nov. 15, 2018

(54) Fixed Mode Clutch Control Methods For A Multi-Mode Ball-Type Continuously Variable Transmission

(71) Applicant: Dana Limited, Maumee, OH (US)

(72) Inventors: Jeffrey M. David, Cedar Park, TX (US); T. Neil McLemore, Georgetown, TX (US)

(21) Appl. No.: 15/976,918

(22) Filed: May 11, 2018

Related U.S. Application Data
(60) Provisional application No. 62/504,887, filed on May 11, 2017.

(51) Int. Cl. F16H 37/02; F16H 3/66; F16H 15/50; F16H 61/12

(52) U.S. Cl. CPC F16H 37/022; F16H 3/66; F16H 2061/1232; F16H 61/12; F16H 2037/023; F16H 15/503

(57) ABSTRACT

Provided herein is a control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The transmission control module includes a CVP control module and a clutch control module. The transmission control module is configured to control the variator and the clutches during a canceled power on upshift, a canceled power on downshift, and a transitional shift based on a driver's command.

### RELATED APPLICATION

The present application claims the benefit of U.S. Provisional Application No. 62/504,887 filed May 11, 2017 which is incorporated herein by reference in its entirety.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations could for example, multiply input torque across the different transmission stages in different manners to achieve the same final drive ratio. However, some configurations provide more flexibility or better efficiency than other configurations providing the same final drive ratio.

### SUMMARY

Provided herein is a vehicle having a continuously variable drive (CVD) including a first rotatable shaft operably coupleable to a source of rotational power, the first rotatable shaft forming a main axis; a continuously variable planetary (CVP), wherein the CVP is a ball variator assembly having a first traction ring assembly and a second traction ring assembly in contact with a plurality of balls, wherein each ball of the plurality of balls has a tiltable axis of rotation and wherein the ball variator assembly is coaxial with the main axis; a CVD input planetary gear set having a ring gear, a planet carrier, and a sun gear, wherein the planet carrier is operably coupled to the first rotatable shaft, the ring gear is coupled to the first traction ring assembly, and the sun gear is coupled to the second traction ring assembly; a locking clutch operably coupled to the CVD input planetary gear set and the CVP, wherein the locking clutch is adapted to selectively engage the CVD input planetary to provide a fixed ratio mode of operation; a multiple speed gearbox having a plurality of selectable operating modes, wherein the multiple speed gearbox is operably coupled to the second traction ring assembly and the sun gear; and a controller configured to control a CVP speed ratio, control the plurality of selectable operating modes, and control engagement and disengagement of the locking clutch, wherein the controller is adapted to detect a request for an engagement of the locking clutch.

Provided herein is a computer-implemented method for controlling an engine and a continuously variable drive (CVD) having a locking clutch and a ball planetary variator (CVP) provided with a ball in contact with a first traction ring assembly, a second traction ring assembly, a first sun member, and a second sun member, the method including the steps of: receiving a plurality of data signals provided by sensors located on the CVD and the engine, the plurality of data signals having: a CVP speed ratio, a CVD speed ratio, an engine speed, an engine torque; determining a first CVD efficiency corresponding to a variable ratio mode of operation based on the CVP speed ratio; determining a second CVD efficiency in a fixed ratio mode of operation based on the CVD speed ratio; determining a first engine energy cost in the variable ratio mode based on the engine speed, the engine torque, and an engine brake specific fuel consumption (BSFC) map; determining a second engine energy cost in a fixed ratio mode based on engine speed, the engine torque, and the engine BSFC map; comparing the difference between the difference between the first CVD efficiency and the second CVD efficiency and the first engine energy cost and the second engine energy cost; and commanding a request to engage the locking clutch based on the comparison.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system that could be implemented in a vehicle.

FIG. 5 is a schematic diagram of an exemplary continuously variable drive configured to be controlled by the vehicle control system of FIG. 4.

FIG. 6 is a table depicting the operating modes of the continuously variable drive of FIG. 5.

FIG. 7 is a flow chart depicting a locking clutch request process that is implementable in the vehicle control system of FIG. 4.

FIG. 8 is a flow chart depicting a cruise evaluation process that is implementable in the vehicle control system of FIG. 4.

FIG. 9 is a flow chart depicting a locking clutch engagement process that is implementable in the vehicle control system of FIG. 4.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller could be configured to receive input signals indicative of parameters associated with an engine coupled to the transmission. The parameters could include throttle position sensor values, accelerator pedal position sensor values, vehicle speed, gear selector position, user-selectable mode configurations, and the like, or some combination thereof. The electronic controller could also receive one or more control inputs. The electronic controller could determine an active range and an active variator mode based on the input signals and control inputs. The electronic controller could control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. Patent Application No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

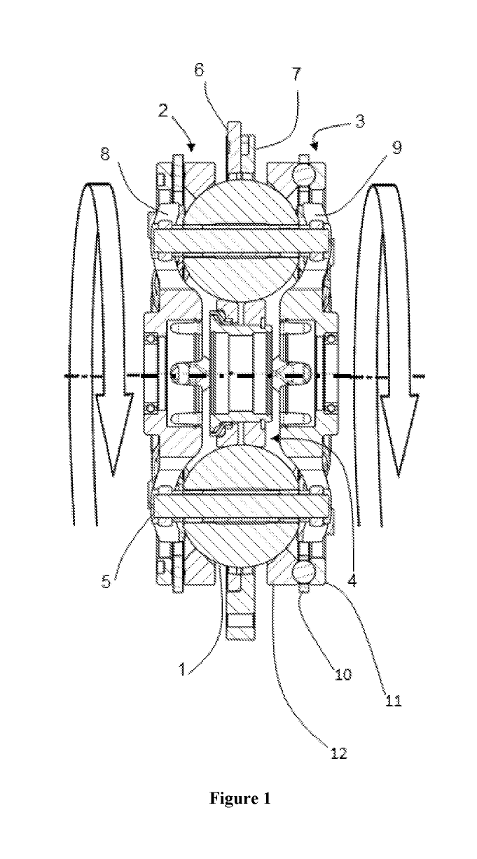

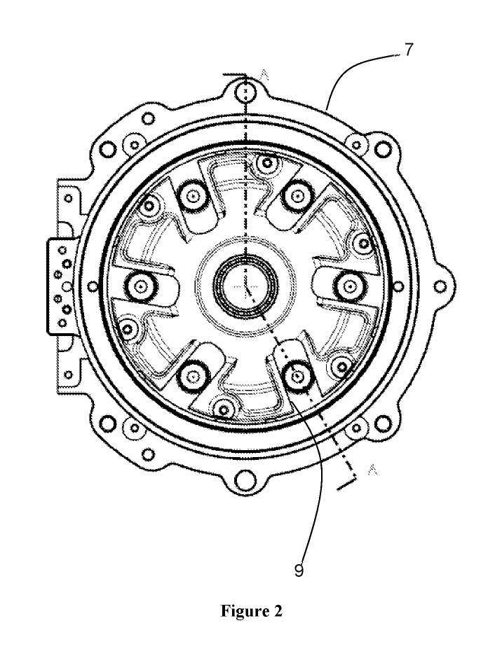

Provided herein are configurations of CVTs based on a ball type variator, also known as CVP, for continuously variable planetary. Basic concepts of a ball type Continuously Variable Transmissions are described in U.S. Pat. No. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input traction ring assembly 2 and output traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

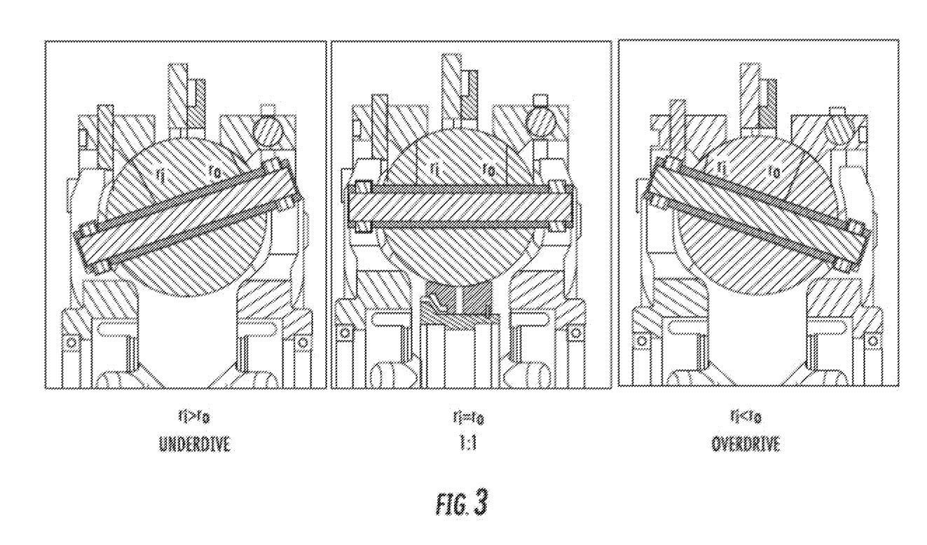

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT comprises a processor (not shown).

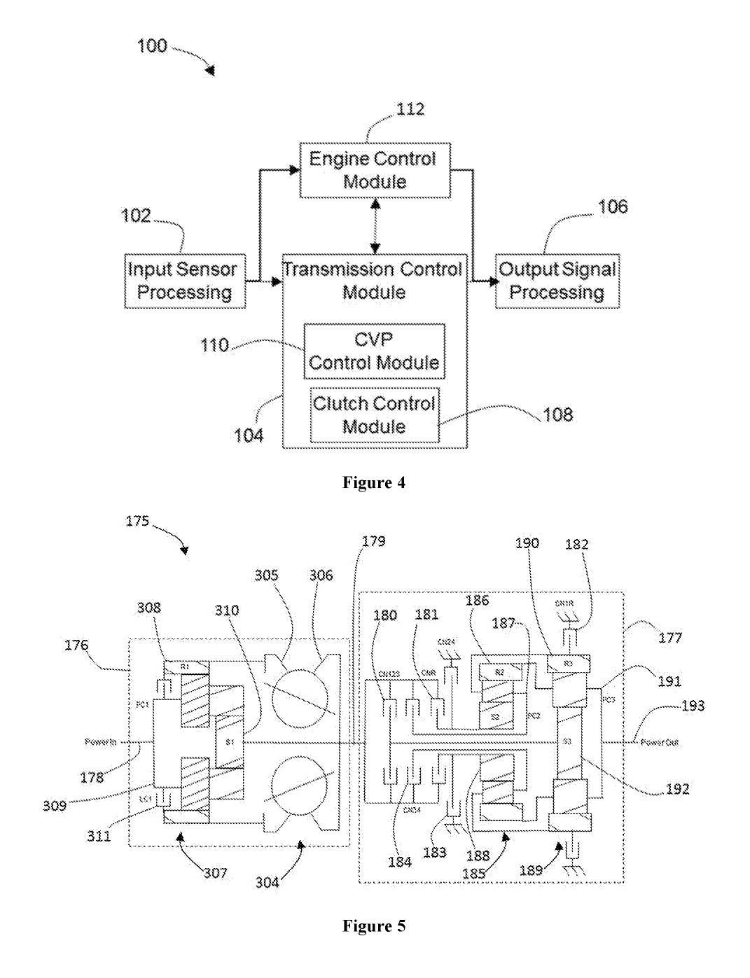

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104.

Referring now to FIG. 5, control and diagnostic methods described herein are related to continuously variable drives having a multiple speed gear box operably coupled to a continuously variable planetary device such as those described in reference to FIGS. 1-3, and disclosed in U.S. Patent Application No. 62/343,297, which is hereby incorporated by reference. As an illustrative example of a continuously variable drive, a schematic is depicted in FIG. 5. It should be understood that there are a variety of transmission architectures that the control and diagnostic methods described herein are applied to. For example, multiple mode transmissions having two, three, four, or more modes are optionally configured to implement the control processes described herein. In some embodiment, a continuously variable drive (CVD) 175 includes a continuously variable device 176 operably coupled to a multiple speed gear box 177. In some embodiments, the continuously variable device 176 is controlled by the CVP control sub-module 110, and the multiple speed gear box 177 is controlled by the clutch control sub-module 108. It should be appreciated that the transmission control module 104 is optionally adapted to control both the continuously variable device 176 and the multiple speed gear box 177. The CVD 175 includes a first rotatable shaft 178 adapted to couple to a source of rotational power (not shown). The continuously variable device 176 includes a variator 304 having a first traction ring assembly 305 and a second traction ring assembly 306.

In some embodiments, the variator 304 is configured such as the variator depicted in FIGS. 1-3. The continuously variable device 176 includes a first planetary gear set 307 having a first ring gear 308, a first planet carrier 309, and a first sun gear 310. The first planetary gear set 307 is sometimes referred to herein as “the input split planetary gear set” having a ring to sun ratio represented by the term “RTS”. The first ring gear 308 is operably coupled to the first traction ring assembly 305. The first planet carrier 309 is operably coupled to the first rotatable shaft 178. The first sun gear 310 is operably coupled to the second traction ring assembly 306. In some embodiments, the first sun gear 310 is operably coupled to a second rotatable shaft 179. The second rotatable shaft 179 is configured to couple to the multiple speed gear box 177. In some embodiments, the continuously variable device 176 is provided with a locking clutch 311 adapted to selectively couple the first ring gear 308 and the first planet carrier 309 to provide bypass of the variator 304 during operation. In some embodiments, the multiple speed gear box 177 is provided with a number of clutch devices including a underdrive clutch 180, a reverse mode clutch 181, a first-and-reverse mode clutch 182, a second-and-fourth mode clutch 183, and a third-and-fourth mode clutch 184. In some embodiments, the multiple speed gear box 177 includes a second planetary gear set 185. The second planetary gear set 185 has a second ring gear 186, a second planet carrier 187, and a second sun gear 188. In some embodiments, the second sun gear 188 is coupled to the second-and-fourth mode clutch 183 and the reverse mode clutch 181. The second planet carrier 187 is coupled to the third-and-fourth mode clutch 184. In some embodiments, the multiple speed gear box 177 includes a third planetary gear set 189 having a third ring gear 190, a third planet carrier 191, and a third sun gear 192. The third sun gear 192 is coupled to the underdrive clutch 180. The third ring gear 190 is coupled to the first-and-reverse mode clutch 182. The second ring gear 186 is operably coupled to the third planet carrier 191. The third planet carrier 191 is adapted to couple to an output drive shaft 193. The output drive shaft 193 is adapted to transmit an output power from the CVD 175 through the range box 177.

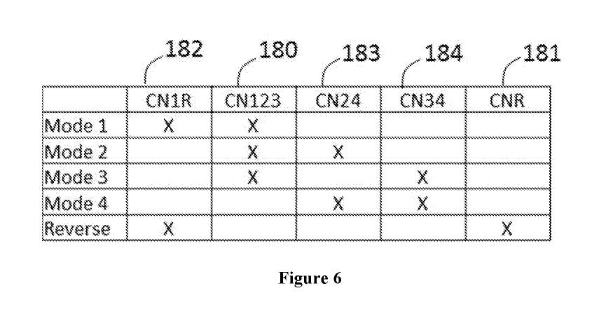

Referring now to FIG. 6, during operation of the CVD 175 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVD 175. The table depicted in FIG. 6, lists the modes of operation for the CVD 175 and indicates with an “x” the corresponding clutch engagement or clutch position. For mode 1 operation, the underdrive clutch 180 and the first-and-reverse mode clutch 182 are engaged. For mode 2 operation, the underdrive clutch 180 and the second-and-fourth mode clutch 183 are engaged. For mode 3 operation, the underdrive clutch 180 and the third-and-fourth mode clutch 184 are engaged. For mode 4 operation, the second-and-fourth mode clutch 183 and the third-and-fourth mode clutch 184 are engaged. For reverse mode operation, the first-and-reverse mode clutch 182 and the reverse mode clutch 181 are engaged. In some embodiments, the locking clutch 311 is selectively engaged during operation to provide a fixed ratio operating mode as an optional gear in any of the modes of operation depicted in FIG. 6. During fixed ratio operating modes, power is transmitting through fixed gear ratios and the variator 304 operates at a 1:1 speed ratio. For example, engagement of the locking clutch 311 in mode 1 provides a fixed ratio for vehicle launch from a stop. The locking clutch 311 can be disengaged when a desired vehicle speed is reach and the vehicle continues to operate in mode 1 with power transmitted through the variator 304. The locking clutch 311 can be engaged during mode 2, mode 3, mode 4, or reverse operation to transmit power through fixed gear ratios and effectively bypass the variator 32.

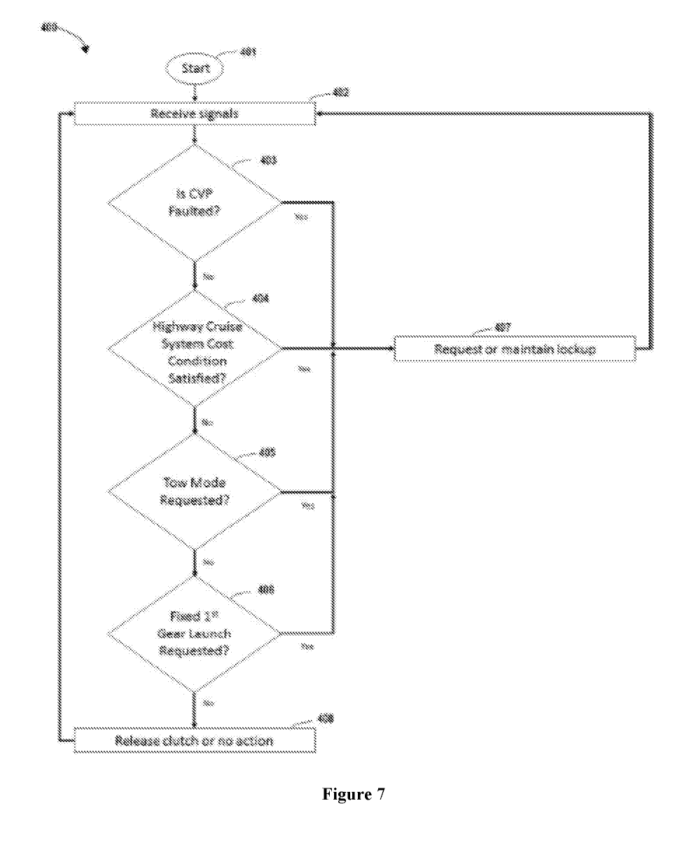

Referring now to FIGS. 7-9, there are a number of vehicle operating scenarios where it is beneficial to operate in a fixed ratio, therefore, there is a need to manage the control of the locking clutch 311. When the variator 304 is bypassed all input torque is routed through the locking clutch 311. When the locking clutch 311 is applied in a limp home mode in case of CVP damage, there exists the possibility of significant slip speed across the locking clutch 311. This generates a significant amount of clutch energy dissipation during the engagement or apply stage of the clutch, and an associated temperature rise. For sizing and design considerations, it is desirable to limit the dynamic apply scenarios for the locking clutch 311. Clutch energy modeling, temperature rise estimation, and a control method flow chart to operate the locking clutch 311 will now be discussed in reference to the FIGS. 7-9.

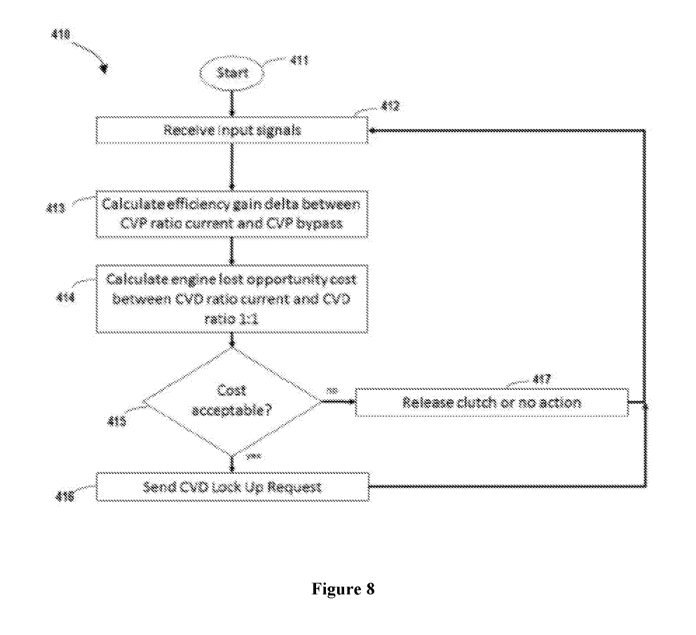

Referring now to FIG. 7, in some embodiments, a locking clutch request process 400 is implemented in the transmission control module 104. The locking clutch request process 400 begins at a start state 401 and proceeds to a block 402 where a number of signals are received. For example, signals indicative of vehicle operating condition are generated by sub-modules in the transmission control module 104 are received in the block 402. The locking clutch request process 400 proceeds to a first evaluation block 403 where a fault condition of the variator 304, for example, is evaluated. In some embodiments, the CVP control module 110 is adapted to monitor a number of fault conditions of the variator 304 during operation. When the first evaluation block 403 returns a false result, indicating that the variator 304 is not in a fault condition, the locking clutch request process 400 proceeds to a second evaluation block 404. The second evaluation block 404 evaluates a highway cruise condition criteria received from a highway cruise evaluation process 410, described in FIG. 8. When the second evaluation block 404 returns a false result, indicating that the CVT 175 is not in a highway cruise condition, the locking clutch request process 400 proceeds to a third evaluation block 405. The third evaluation block 405 evaluates a tow mode signal received by the transmission control module 104 from an operator request, for example, from a driver selectable switch within the vehicle. A tow mode request while the vehicle is moving corresponds to the transmission control module issuing commands to control the ratio CVD 176 to 1:1 and synchronize clutch speeds. When the third evaluation block 405 returns a false result, indicating that there is no request for a tow mode, the locking clutch request process 400 proceeds to a fourth evaluation block 406 where a launch condition of the vehicle is evaluated. A launch condition is sometimes based on a driver selectable manual +/− shift gate located on the shifter. In some embodiments, a fixed first gear launch is optionally used for power capacity, among other design considerations. When the fourth evaluation block 406 returns a false result, indicating that a launch condition is not active, the locking clutch request process 400 proceeds to a block 408 where a command is sent to release the locking clutch 311 if it is engaged or take no action if the locking clutch 311 is released. When the first evaluation block 403, the second evaluation block 404, the third evaluation block 405, or the fourth evaluation block 406 return a true result, the locking clutch request process 400 proceeds to a block 407 where a commend is sent to apply the locking clutch 311 or maintain the engagement of the locking clutch 311 if the locking clutch 311 is already engaged. The locking clutch request process 400 returns to the block 102.

Turning now to FIG. 8, in some embodiments, a cruise evaluation process 410 is implemented to the transmission control module 104 to provide a signal to the locking clutch request process 400 that indicates that a vehicle equipped with the CVT 175 is at a highway cruise condition. It should be appreciated that a highway cruise condition is applicable for vehicles, such as hybrid-electric vehicles, to provide a bypass of the CVP and thereby improve system efficiency. The cruise evaluation process 410 begins at a start state 411 and proceeds to a block 412 where a number of input signals are received from the transmission control module 104. For example, the input signals include an engine speed, an engine torque, a speed ratio of the variator 304, a speed ratio of the CVT 175, an accelerator pedal position, a throttle pedal position, a vehicle speed, among others. The cruise evaluation process 410 proceeds to a block 413 where an efficiency gain between the current variator operating condition and a bypass of the variator is calculated. Since the engagement of the locking clutch 311 provides a bypass of the variator 304 during steady state highway cruising of the vehicle, and is a unique case where the expected efficiency gain from bypassing the variator 304 is offset by higher engine fuel consumption from operating the engine at a less optimal point on the BSFC map, the overall system benefit to be realized must satisfy the following inequality:

ΔPᵥₐᵣᵢₐₜₒᵣ_{_}_{efficiency}_{_}_{gain}−ΔP_{engine}_{_}ₗₒₛₜ_{_}_{opportunity}≥0+P_{hysteresis}

Units for the above equation are expressed in watts (W). The variator efficiency gain (“ΔPᵥₐᵣᵢₐₜₒᵣ_{_}_{efficiency}_{_}_{gain}”) is calculated in the block 413 by multiplying current required drive cycle input power by the efficiency delta of the variator between the current cruise CVP ratio and the required 1:1 ratio during engagement of the locking clutch 311. This is expected to be a positive value. The cruise evaluation process 410 proceeds to a block 414 where the lost opportunity cost for the engine (“ΔP _{engine}_{_}ₗₒₛₜ_{_}_{opportunity}”) is determined as the current input power multiplied by the BSFC delta between the current operating point and the higher engine speed operating point required by the 1:1 CVP ratio. This represents the lost opportunity that exists due to intentionally operating the engine at a less efficient point and is expected to be a negative value. The cruise evaluation process 410 proceeds to an evaluation block 415 where the variator efficiency gain (“ΔPᵥₐᵣᵢₐₜₒᵣ_{_}_{efficiency}_{_}_{gain}”) is compared to the lost opportunity cost for the engine (“ΔP_{engine}_{_}ₗₒₛₜ_{_}_{opportunity}”). If the evaluation block 415 returns a false result, indicating that the inequality is not acceptable, the cruise evaluation process 410 proceeds to a block 417 where a command is sent to release the locking clutch 311 or take no action if it is released. The cruise evaluation process 410 returns to the block 412. In some embodiments, a calibrateable hysteresis value (“P_{hysteresis}”) is added in the evaluation block 415 to prevent rapid changes in lock-up request state and to ensure that the power loss associated with making the shift does not negate any potential savings. If the evaluation block 415 returns a true result, indicating that the inequality is satisfied, the cruise evaluation process 410 proceeds to a block 416 where a request signal is sent to engage the locking clutch 311. In some embodiments, the signal is received in the second evaluation block 404 of the locking clutch request process 400. The cruise evaluation process 410 returns to the block 412.

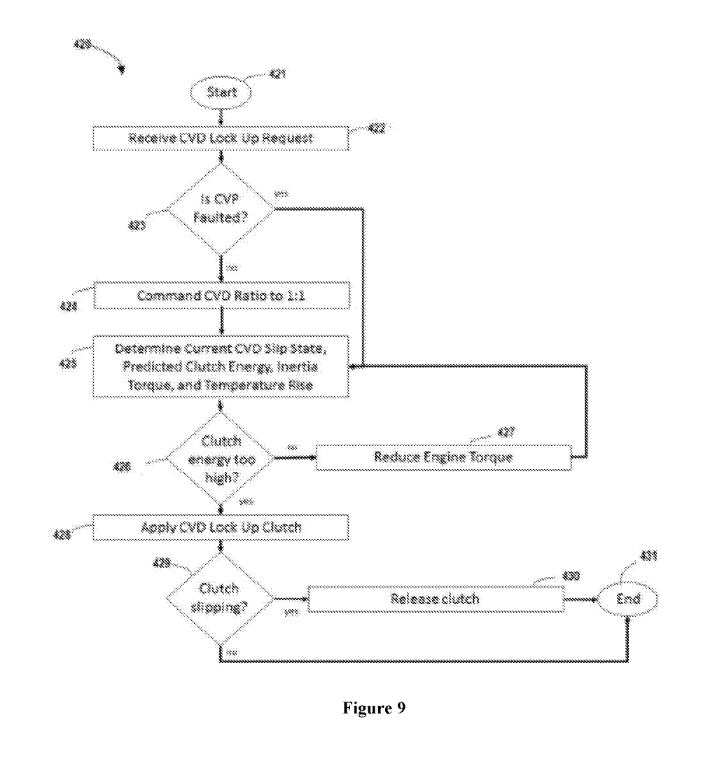

Turning now to FIG. 9, in some embodiments, a locking clutch engagement process 420 is implementable in the transmission control module 104. The locking clutch engagement process 420 begins at a start state 421 and proceeds to a block 422 where a request to engage the locking clutch 311 is received. In some embodiments, the request signal received in the block 422 is provided by the locking clutch request process 400. The locking clutch engagement process 420 proceeds to a first evaluation block 423 where a fault condition of the variator 304, for example, is evaluated. If the first evaluation block 423 returns a false result, indicating that there is no fault condition for the variator 304, the locking clutch engagement process 420 proceeds to a block 424 where a command is send to adjust the continuously variable device (CVD) 176 to a 1:1 ratio. If the first evaluation block 423 returns a true result, indicating that there is a fault condition of the variator 304, the locking clutch engagement process 420 proceeds to a block 425 where a number of factors corresponding to the operating condition of the CVD 176 are determined. The block 425 is optionally entered from the block 424.

Still referring to FIG. 9, in some embodiments, the block 425 implements the following calculations to determine a slip state of the CVD 176, a predicted locking clutch 311 energy including an inertia torque and temperature rise. It should be noted that torque capacity (“T_{capacity}”) varies throughout the apply time of the clutch and consists of the required capacity to handle the engine input torque plus an additional capacity necessary to execute the inertia phase of the shift where an inertia load is present on the clutch due to the required engine speed change. For a typical friction clutch, the following equations for torque capacity and force apply:

$${T}_{capacity} = {F}_{apply} * {r}_{friction} * {mu}_{friction} * {\#}_{{friction}_{—} surfaces}$$

$${F}_{apply} = {F}_{piston} - {F}_{{return}_{—} spring}$$

$${F}_{piston} = {P}_{apply} * {A}_{piston}$$

$${r}_{friction} = \frac{{r}_{o} + {r}_{i}}{2} = effective fraction radius$$

In some embodiments, the block 425 evaluates the clutch energy. Instantaneous power dissipated across a slipping clutch is the product of torque capacity and slip speed. The total energy absorbed by the clutch is calculated in the following equations:

E_{clutch}=½T_{avg}*Nₛₗᵢₚ*t_{shift}

T_{avg}=average clutch torque during shift (Nm)

Nₛₗᵢₚ=Nᵢₙₚᵤₜ−N_{CVP}_{_}_{R1}=speed difference across CVD clutch (rad/s)

t_{shift}=CVD clutch apply time (s)

The model above assumes linear profile for the clutch slip speed and an average torque value on the clutch. This leaves the calculation of the average torque on the clutch and the distribution across the torque and inertia phases unresolved. A more detailed model is given below which accounts for a realistic slip speed profile and the changing torque capacity on the clutch during the shift. For discussion and analytical purposes, the shift is split into the torque and inertia phases with a basic assumption that each phase is equal to half the total shift time in length. The torque capacity is modeled with a linear ramp where the capacity is equal to the input torque at the end of the torque phase of the shift. Slip speed does not change during the torque phase.

$${T}_{cap} = \frac{t}{k} {T}_{eng} where k = {t}_{shift}$$

$${N}_{slip} = {N}_{i} = initial slip speed across clutch ( rad \text{/} s )$$

The torque on the clutch during the inertia phase is modeled as the sum of the engine torque and the required inertia torque to execute the speed change in the allotted time. Slip speed is modeled as a linear profile decreasing from the initial slip value to 0 during the inertia phase.

$${N}_{slip} = {N}_{i} - \frac{t}{0.5 k} {N}_{i} where k = {t}_{shift}$$

$${T}_{total} = {T}_{eng} + {T}_{inertia}$$

The clutch energy is the integral of the modeled clutch torque and the slip speed across the shift duration over the duration of the shift. This is integrated separately for each phase of the shift.

E_{clutch}=∫ₒ^{t}^{_{shift}}T_{clutch}*Nₛₗᵢₚ dt

Substituting the individual functions and integrating produces the following.

$${E}_{clutch} = {\int }_{o}^{{t}_{shift \text{/} 2}} \frac{t}{k} {T}_{eng} {N}_{slip} dt + {\int }_{o}^{{t}_{shift \text{/} 2}} {T}_{total} ( {N}_{slip} - \frac{t}{0.5 k} {N}_{slip} ) dt$$

$${E}_{clutch} = \frac{{N}_{slip} {T}_{eng} t}{k} + {T}_{total} ( {N}_{slip} t - \frac{{N}_{slip} {t}^{2}}{k} )$$

A variety models are possible for control systems where closed loop slip speed profiles may be linear, sinusoidal, or a power series and the resulting clutch torque capacity would be non-linear as the control loop tracks the specified slip speed target.

Still referring to FIG. 9, in some embodiments, the block 425 is adapted to determine the temperature rise in the clutch. Due to the insulating properties of the friction material used in typical clutches, a heat transfer coefficient (“X”) is assumed quantifying the amount of heat that is transferred to the separator plates. Pressure and reaction plates are ignored due to single side heat exposure, larger thermal mass, and influence of friction material. Equation for the temperature rise in a dual sided steel separator plate is given below. For a single sided separator plate delete the 2 in the numerator.

$$Δ {T}_{ds} = X \frac{2 * {E}_{clutch}}{N * m * {C}_{s}}$$

The results from the thermal simulation are easily adapted to a look up table of allowable input torque and locking clutch 311 slip speed combinations to limit predicted temperature rise to a predetermined calibration value. An additional axis can be used to allow a varying temperature rise based on current fluid temperature. A lower limit is necessary if an increased CVD clutch duty cycle is required.

Δt_{ds}+Tₒᵢₗ≤Tₗᵢₘᵢₜ

In some embodiments, the locking clutch engagement process 420 proceeds to a second evaluation block 426 where predicted clutch energy is compared to a predetermined calibrateable threshold. The second evaluation block 426 is optionally adapted to evaluate the thermal condition of the clutch compared to a threshold. Thus, CVD clutch apply is disallowed if the above inequality is not satisfied. If the second evaluation block 426 returns a false result, the locking clutch engagement process 420 proceeds to a block 427 where a command is send to the engine control module 112 to reduce the engine torque. If the second evaluation block 426 returns a true result, the locking clutch engagement process 420 proceeds to a block 428 where a command to apply the locking clutch 311 is issued. Because the locking clutch 311 is potentially used as a fail-safe device when faults are detected in the variator 304, a synchronization routine is optionally implemented in the block 428 to bring slip speed and clutch torque to manageable levels prior to engaging the locking clutch 311. The locking clutch engagement process 420 proceeds to a third evaluation block 429 where a slip condition of the locking clutch 311 is evaluated over a predetermined time period. In some embodiments, the third evaluation block 429 is adapted to perform the evaluation of the slip condition for a calibrateable time period in order to confirm engagement of the locking clutch 311. It should be noted that when the variator 304 is not in a fault condition and the overall CVD 176 ratio can be brought to 1:1 prior to applying the locking clutch 311, there is effectively no inertia phase when applying the locking clutch 311. Clutch energy during this synchronous engagement is minimal due to negligible slip speeds. When the third evaluation block 429 returns a false result, indicating that the locking clutch 311 is not slipping, the locking clutch engagement process 420 proceeds to an end state 431. When the third evaluation block 429 returns a true result, indicating that the locking clutch 311 is slipping, the locking clutch engagement process 420 proceeds to a block 430, where the locking clutch 311 is released. The locking clutch engagement process 420 ends at a state 431. Clutch energy during engagement of the locking clutch 311 is regulated by limiting the torque level and slip speed ranges where apply is allowed using calibration limits previously determined with thermal simulation equations. The locking clutch 311 requires additional capacity for a non-synchronous shift when the variator 304 is faulted due to the inertia torque required to pull the engine speed down. This is calculated as below.

$${T}_{inertia} = I * α * {STR}_{converter}$$

$$I = combined engine and trans input inertia ( kg {m}^{2} )$$

$$α = \frac{{ω}_{1} - {ω}_{2}}{t} = \frac{{N}_{slip} - 0}{{t}_{shift \text{/} 2}} = acceleration ( rad \text{/} {s}^{2} )$$

In some embodiments, the block 430 is adapted to evaluate and send a fault signal for the locking clutch 311. When the locking clutch 311 is closed the CVD 176 ratio is 1:1, therefore when the locking clutch 311 is engaged, the input shaft speed must be equal to the first traction ring 305 speed. A locking clutch 311 fault is determined when the locking clutch 311 is commanded on and the input shaft speed is not equal to the first traction ring 305 speed. An illustrative example of a CVD clutch slip calculation is also described in U.S. Patent Application No. 62/441,721 entitled “Modular Powerpath Slip Diagnostics”, which is hereby incorporated by reference. When locking clutch 311 slip fault is detected it is recommended to reduce engine torque to prolong the life of the locking clutch 311. For the case where the variator is not faulted it may be acceptable to disable the CVD clutch.

Additionally, provided herein is a computer-implemented method for controlling an engine and a continuously variable drive (CVD) having a locking clutch and a ball-planetary variator (CVP) provided with a ball in contact with a first traction ring assembly, a second traction ring assembly, a first sun member, and a second sun member, the method including the steps of: receiving a plurality of data signals provided by sensors located on the CVD and the engine, the plurality of data signals including: a CVP speed ratio, a CVD speed ratio, an engine speed, and an engine torque; determining a first CVD efficiency corresponding to a variable ratio mode of operation based on the CVP speed ratio; determining a second CVD efficiency in a fixed ratio mode of operation based on the CVD speed ratio; determining a first engine energy cost in the variable ratio mode based on engine speed, the engine torque, and an engine brake specific fuel consumption (BSFC) map; determining a second engine energy cost in a fixed ratio mode based on the engine speed, the engine torque, and the engine BSFC map; comparing the difference between the difference between the first CVD efficiency and the second CVD efficiency and the first engine energy cost and the second engine energy cost; and commanding a request to engage the locking clutch based on the comparison.

In some embodiments, the variable mode of operation corresponds to a power transmitted.

In some embodiments, the fixed mode of operation corresponds to a power transmitted through a fixed ratio path with no power transmission through the CVP.

In some embodiments, the method further includes the step of commanding a change in an engine operating condition based on the request to engage the locking clutch.

In some embodiments, commanding a change in the engine operating condition further includes reduces an engine torque command.

In some embodiments, the method further includes the step of determining a slip condition in the locking clutch.

In some embodiments, determining a slip condition of the locking clutch further includes comparing a CVD input speed and a CVP input speed.

In some embodiments, the method further includes the step of sending a fault condition signal based on determining a slip condition in the locking clutch.

In some embodiments, sending a fault condition signal further includes commanding a reduction in the engine torque.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein could be employed in practicing the preferred embodiments. It is intended that the following claims define the scope of the preferred embodiments and that methods and structures within the scope of these claims and their equivalents be covered thereby.

What is claimed is:

1. A vehicle comprising:
a continuously variable drive (CVD) comprising:
a first rotatable shaft operably coupleable to a source of rotational power, the first rotatable shaft forming a main axis;
a continuously variable planetary (CVP), wherein the CVP is a ball variator assembly having a first traction ring assembly and a second traction ring assembly in contact with a plurality of balls, wherein each ball of the plurality of balls has a tiltable axis of rotation and wherein the ball variator assembly is coaxial with the main axis;
a CVD input planetary gear set having a ring gear, a planet carrier, and a sun gear, wherein the planet carrier is operably coupled to the first rotatable shaft, the ring gear is coupled to the first traction ring assembly, and the sun gear is coupled to the second traction ring assembly;
a locking clutch operably coupled to the CVD input planetary gear set and the CVP, wherein the locking clutch is adapted to selectively engage the CVD input planetary gear set to provide a fixed ratio mode of operation; and
a multiple speed gearbox having a plurality of selectable operating modes, wherein the multiple speed gearbox is operably coupled to the second traction ring assembly and the sun gear; and
a controller configured to control a CVP speed ratio, control the plurality of selectable operating modes, and control engagement and disengagement of the locking clutch, wherein the controller is adapted to detect a request for an engagement of the locking clutch.

2. The vehicle of claim 1, wherein the controller is adapted to monitor a fault condition of the CVP and send a request to engage the locking clutch based on a detection of a fault condition of the CVP.

3. The vehicle of claim 1, wherein the controller is adapted to determine a request for a highway cruise condition of the vehicle and send a request to engage the locking clutch based on the detection of the request for a highway cruise condition.

4. The vehicle of claim 1, wherein the controller is adapted to detect a request for a tow mode of operation and send a request to engage the locking clutch based on the detection of the request for a tow mode of operation.

5. The vehicle of claim 1, wherein the controller is adapted to detect a request for a launch condition of the vehicle and send a request to engage the locking clutch based on the detection of the request for the launch condition of the vehicle.
